(19) United States
(12) Patent Application Publication
(10) Pub. No.: US 2016/0300293 A1
(43) Pub. Date: Oct. 13, 2016

(54) DEVICE, SYSTEM AND METHOD FOR DESIGNING A SPACE

(71) Applicant: RON NAGAR, TEL-AVIV (IL)

(72) Inventor: RON NAGAR, TEL-AVIV (IL)

(21) Appl. No.: 15/037,708

(22) PCT Filed: Nov. 19, 2014
(86) PCT No.: PCT/IL2014/000059

§ 371 Date: May 19, 2016

Related U.S. Application Data
(60) Provisional application No. 61/905,997, filed on Nov. 19, 2013.
(60) Provisional application No. 61/924,388, filed on Jan. 7, 2014.
(60) Provisional application No. 62/063,045, filed on Oct. 13, 2014.

(51) Int. Cl. G06Q 30/06; G06F 3/0482; G06F 3/0484; G06F 3/0481; G06F 3/01; G06Q 20/10; G09G 3/00

(52) U.S. Cl. CPC G06Q 30/0643; G06Q 30/0631; G06Q 20/102; G06F 3/0482; G09G 3/002; G06F 3/04815; G06F 3/017; G06F 3/04845

(57) ABSTRACT

Embodiments of the present disclosure are directed to methods, systems and devices for designing a commercial or residential space via a design application. For example, in some embodiments, a method is disclosed which enables a user to input information, including, for example, photos or video of the space, lighting, color(s). user preferences, measurements and the configuration and/or location of openings in the space. In such embodiments, the user can select a design theme, style or designer, and based on the information input (or acquired), the method presents recommendations of a new design for the space, which may include recommendations of products to furnish the space. Further embodiments also include enabling the user to purchase such products, and may also allow the user to hire service personnel to construct the recommended design and/or install selected/purchased products.

### CROSS-REFERENCE TO RELATED APPLICATIONS

This application claims priority to U.S. Provisional Patent Application No. 61/905,997, filed Nov. 19, 2013, and entitled “Device System and Method for Internal Design Recommendation and Purchasing”; U.S. Provisional Patent Application No. 61/924,388, filed Jan. 7, 2014, and entitled “Device System and Method for Internal Design Recommendation and Purchasing”; U.S. Provisional Patent Application No. 62/063,045, filed Oct. 13, 2014, and entitled “Device System and Method for Internal Design Recommendation and Purchasing” the disclosures of which are incorporated herein by reference in their entireties.

### TECHNICAL FIELD

Some embodiments of the present disclosure generally relate to devices, systems and methods for providing recommendations and options for exterior and interior design and/or overall house design and architecture.

### BACKGROUND

Interior design is the art of transforming an interior space to a designated surrounding, such as a residential house, a selected room, such as a bedroom, bathroom, etc., an office, or a shopping facility, for example. Interior design may include selection of a multiplicity of elements, such as, for example, furniture, lighting, painting, flooring, tiling, carpentry and decorations. Interior design may also involve selections relating to the infrastructure of the interior space, such as placements of electric outlets, plumbing connections, and light switches. Interior design may also include any selections related to the art of transforming the interior space to the designated surrounding.

Exterior design is the art of transforming an exterior space to a designated surrounding. It can include selection of any of the abovementioned multiplicity of elements. Exterior design may also include landscaping, gardening, or outdoor products (e.g. furniture, mailbox, garbage disposal) or any selection related to the art of transforming the exterior space to the designated surrounding.

Architecture is the art of designing, planning and constructing buildings or any other physical structure. The architectural design can include selection of the form of the building or physical structure.

Design selections may include many aspects, such as style, color, texture, shape and size, for example.

### SUMMARY OF DISCLOSURE

According to some embodiments, devices, systems and methods are presented which provide at least one of recommendations and options for exterior and interior design and/or overall home design and architecture. The recommendations and options may be based on various types of information, such as, in a non-limiting example: user preferences and input, image input, sound input, location input, and other input from user mobile devices, and/or any other input device. Additionally, recommendations and options may be based on other information, which the system can access on the web. The devices, systems and methods may further allow ordering, purchasing and hiring directly (e.g., electronically, via online for example), including payment, of products, other services and/or service providers recommended by the system. Additionally, the system may provide a commission from the purchase and/or service to the system administrator or any other entity.

According to some embodiments, there is disclosed a tool/device (e.g., mobile device, graphical-user-interface or GUI) for providing guidance to a user for allowing the user to provide various types of information. The information may be provided by the user through user input or the information may be provided without user input, by using sensors provided by the device, and/or combination thereof. In a non-limiting example, providing the information may include setting preferences, taking pictures, videos, sound recordings, using area maps, and/or geographical information, as data input for an algorithm. The algorithm may apply design rules, which can be in accordance with rules of a specific interior or exterior design style, designer or architect (these terms used interchangeably throughout the present disclosure, i.e., each term being discussed herein can stand for any and/or all such terms). The algorithm may use one or more databases of products and/or services associated with a selected design style to provide the user with design recommendations. The design recommendations may include any element related to design, such as, in a non-limiting example, types of products (e.g. furniture, flooring), color schemes, and placement of infrastructure (e.g., plumbing, lighting, and/or air conditioning). The tool may provide the user the recommendations in real time or within a specific time period. The tool may allow the user to visualize the proposals in 3D augmented reality, virtual reality or a combination of both augmented and virtual reality or by any other user interface. The tool may allow the user to select from suggested proposals, including using gesture sensing for making selections and moving objects around in virtual and/or augmented reality, as well as online ordering and payment for selected products, while providing a commission of sales performed by the system to the system manager or other entity. In some embodiments a photograph of the resulted design proposal after realization in the space, is taken and uploaded to the server database relating to a selected design scheme reflecting a specific interior or exterior design style, designer, design house or architect, and optionally suppliers of products and/or services. In another embodiment the system allows user rating and other feedback with respect to a selected design scheme reflecting a specific interior or exterior design style, designer, design house or architect, and optionally suppliers of products and/or services.

According to some embodiments, there may be provided a device according to the present disclosure. The device may include the following modules and features:
An imaging module—to take photos and/or video of the inner and outer sides of the location of a selected interior and/or exterior space to be designed. This can be a cell phone camera or a standalone camera or any other suitable imaging mechanism.
A user interface module—allows a user to input data or select from predetermined menus. The user interface module may include an input module for allowing the user to input information. The user interface may include an output module allowing the user to receive information.
A visualization module—for displaying to the user the proposed options and even may provide a “virtual tour” of the proposed design based on the photos taken by the user and the products selected for the design. The display may include proportional presentations of the products with respect to the actual size of the location. The display can be on the cell phone screen, on a desktop computer or other mobile device screen, or any other means for display.
A gesture sensing module—capable to detect movement of the user's body parts in space.
A communication module—to allow information transfer from and to the user and between the various modules of the system. This can be cellular or WiFi communication or other wireless communication or any other form of communication.
A server module—which hosts some or all the databases, algorithm and software required to perform the various tasks according to the present disclosure. This may include updating the database by information provided from selected interior or exterior designers, design house or architect, suppliers and providers, performing online ordering and payments by the user to selected suppliers and providers while handling commission payments to selected interior or exterior designers, design house or architect.
An Internet connection or a communication network connection—to allow information flow between the server module and the various modules, which the user can access.

Additional modules and features may be included, for example:
A GPS module and/or map module to provide the software information pertaining to the geographical location of the site and the surrounding area, as well as provide the software application GPS information on any GPS location selected by the user (e.g., a tropical location, a mountain location, an urban location).
A sound module for providing the software sound recordings of the area and optional voice user preferences and optional voice guidance to the user for performing certain activities. This can be a microphone and a speaker of a cellular phone or other mobile device, for example.
Data from social networks (for example), indicated by the user as potential parameters for the interior and/or exterior design and/or products.
A design rules and/or template module, configured to host design rules or design templates of at least one designer, design house, architect, generally reflecting their design genre or theme. Design rules may include decorating guidelines or templates set forth by a selected designer (and/or architect and/or design house) to allow following the designers decorating style. This may include specific selection of colors, patterns and/or sizes, for example. Design rules may include basic design rules typically practiced by most designers and architects. An exemplary basic design rule may be to refrain from placing the bed near a door. In some embodiments, the design rules may include preferable design rules. An exemplary preferable design rule may be to place a television in front of the bed. In some embodiments, the design rule may include rules relating to the arrangement of products within the space.
An object module configured to host information of at least one object, including but not limited to, dimensions, weight, color, structure, location, a 3D display of the object, price and/or supplier. The object may also be referred to as “item” and both the object and item may be referred to as “product”.
One or more algorithms, which may be embedded in at least one of a processor of a remote server (or any server), or in a mobile or desktop device. The server may receive all the data captured by the user and other user preferences. The algorithm may be configured to apply the design rules preset by a specific designer, design house and/or architect in order to provide a proposal for a design. The proposal can be sent in real time or later in time to the user devices for visualization, manipulation and/or ordering.

In some embodiments, a commission for at least each order performed by the system may be transferred to the system manager or any other suitable entity. The commission can be paid by the supplier, the user or both.

In some embodiments, there may be provided a method of interior and/or exterior design. The method includes interacting and receiving data through communication modules based on internet connection from imaging modules, gesture sensing modules, sound modules, GPS modules, map modules, user interface modules, design rule modules, and object modules executing a routine on a computing processor to determine a project design based on the input data and interaction, send project output data with objects selection to visualization module, while optionally interacting with input data modules (like GPS modules and gesture sensing modules) after a certain timeframe from data input, and transfer commission to a predefined address location.

In some embodiments, the system may include a computer program product encoded on a non-transitory computer readable storage medium, which may include instructions, that when executed by a data processing apparatus, cause the data processing apparatus to perform the method for designing a space.

In some embodiments, the system may allow the user to select a designer based on designer details and previous exemplary work.

In some embodiments, user input through the user interface module may include one or a combination of user specific traits, such as, but not limited to, a weighted list of user styles, a budget range, maximum and/or minimum budget thresholds, user personal details, income, family status or family size.

In some embodiments, an exemplary interior and/or exterior design system includes a portable electronic device (e.g., personal digital assistant, smart-phone, tablet computer, ultra-mobile PC, Google Glass or similar device) communicating (e.g., wirelessly or via a wired connection, such as Ethernet or USB) with a communication network and/or a remote computing device. The communication network may include a cloud computing service (also referred to as a cloud) having a cloud server and cloud storage in communication with a portal e.g., web portal for receiving/transmitting content.

Cloud computing may provide Internet-based computing, whereby shared servers provide resources, software, and data to computers and other devices on demand. For example, the cloud may be a cloud computing service that includes at least one server computing device or system, which may include a service abstraction layer and a hypertext transfer protocol wrapper over a server virtual machine instantiated thereon. The server computing system may be configured to parse HTTP requests and send HTTP responses. Cloud computing may be a technology that uses the Internet and central remote servers to maintain data and applications. Cloud computing can allow users to access and use applications without installation and access personal files at any computer with internet access. Cloud computing allows for relatively more efficient computing by centralizing storage, memory, processing and bandwidth. The cloud can provide scalable, on-demand computing power, storage, and bandwidth. The cloud storage can be a model of networked computer data storage where data is stored on multiple virtual servers, generally hosted by third parties.

In some embodiments, the system according to the present disclosure may provide the user with data pertaining to service providers which are related to the interior and/or exterior design project. For example, a service provider may be a constructor, which can be recommended and rated by the system. The user may select a service provider which then receives the data captured by the user as well as the interior and/or exterior design recommended and selected by the user. The service provider can then provide the user with a response that may include, but is not limited to, cost and timeline for providing the service. The user may select the service provider and the system administrator may receive a commission from the service provider. Service providers may further be rated by previous users, and rating can be available to the user at any stage of the process or by a predetermined procedure, such as for example, by payment of a fee. In some embodiments, this information can be available for certain users (for example—premium users that pay a certain fee), while other users do not have access to the information.

Such a system is used to qualify the service provider and suppliers linking them to brand name, architects and interior and/or exterior designers, thereby providing high quality rating to the end users of a design application provided for designing a space.

According to some embodiment of the present disclosure there is provided a method for designing a commercial or residential space via a design application operating on a mobile device, the method comprising activating the design application on the mobile device; selecting a space for design from a plurality of spaces, the plurality of spaces comprising a room, an apartment, a house, a garden, a yard, a commercial space, and combinations thereof; receiving information on the current design of the space via at least one of photos or video scanning of the space, light in the space, color(s) of the space, user preferences, measurements of the space, configuration and/or location of openings in the space, GPS location of the space or a designated GPS location (e.g., tropical location, mountain location, urban location), a neighborhood surrounding the space, current items and/or other features of the space, sounds of and/or adjacent the space, and temperature and/or humidity of the space and/or of a selected GPS location; determining dimensions of the space; selecting a design scheme from a plurality of design schemes for re-designing the space, wherein the plurality of design schemes are stored on at least one database; determining one or more products and/or services from a listing of products and/or services stored on at least one database, the determined one or more products and/or services being associated with the design scheme; rendering a virtual map of the space according to the design scheme, the virtual map including a visual representations of at least one of the one or more determined products; and presenting the virtual map of the space to a user.

In some embodiments, the method may further comprise rendering a virtual map of the current design of the space and/or presenting the virtual map of the current design of the space. Each of the one or more products may be associated with a predetermined supplier. Each of the one or more services may be associated with a predetermined service provider. The predetermined supplier may be located within a predetermined distance from the GPS location of the space (or a designated GPS location, e.g., near a contractor or designer's home location).

In some embodiments, the method may further comprise selecting at least one of the one or more products and/or services to purchase and/or hire. The method may further comprise ordering the selected at least one product from the corresponding predetermined supplier thereof. The method may further comprise ordering the selected at least one service from the corresponding predetermined provider thereof.

In some embodiments, at least one of the determined products and services correspond to promoted products and services. In some embodiments, presenting the virtual map comprises a virtual tour. Presenting the virtual map may comprise projecting at least a portion of the virtual map onto a wall of the space, wherein the projected portion of the virtual map corresponds to the wall of the space. The virtual map may be presented via a three-dimensional (3D) visor/glasses. Hand gestures of the user are captured and presented with the virtual map via the 3D visor.

In some embodiments, the method may further comprise alternately presenting the virtual map of the space according to the design scheme and presenting a virtual map of the current design of the space based on a user input. An order of the products and/or services associated with a design scheme may be based on a ranking of the products and services. Each design scheme of the plurality of design schemes may be associated with one or more design rules. Each design scheme of the plurality of design schemes may be associated with a designer or architect. Each design scheme from the plurality of design schemes may be associated with at least one of a budget, style, a budget range, family status, and family size.

In some embodiments, the method may further comprise at least one of: uploading a picture comprising images from the virtual map, sharing with other users; rating the picture; and receiving feedback from the other users related to the uploaded picture.

According to some embodiment of the present disclosure there is provided a method for designing a commercial or residential space via a design application operating on a mobile device, the method comprising: activating the design application on the mobile device; selecting a space for design from a plurality of spaces, the plurality of spaces comprising a room, an apartment, a house, a garden, a yard, a commercial space, and combinations thereof; receiving information on the current design of the space via at least one of photos or video scanning of the space, light in the space, color(s) of the space, user preferences, measurements of the space, configuration and/or location of openings in the space, GPS location of the space or a designated GPS location (e.g., tropical location, mountain location, urban location),a neighborhood surrounding the space, current items and/or other features of the space, sounds of and/or adjacent the space, and temperature and/or humidity of the space and/or of the selected GPS location; determining dimensions of the space; rendering a first virtual map of the space; optionally presenting the first virtual map of the space to a user; selecting a design scheme from a plurality of design schemes stored on at least one database; accessing a predetermined list of products and/or services available from a listing of predetermined suppliers thereof stored on at least one database, wherein each of the products are associated with one or more specific design schemes of the plurality of design schemes; determining one or more products and/or services for the space according to the selected design scheme, the one or more products and/or services associated with predetermined suppliers and/or providers thereof, wherein each of the products and/or service is associated with one or more of the design schemes of the plurality of design schemes; rendering a second virtual map of a re-design of the space according to the design scheme which includes visual representations of at least one of the one or more determined products; presenting the second virtual map of the space to the user; selecting at least one of the one or more products and/or services to purchase and/or hire; purchasing and/or hiring the selected at least one product and/or services from the corresponding predetermined supplier and/or provider thereof.

According to some embodiment of the present disclosure there is provided a system for designing a commercial or residential space comprising a mobile computer device having a processor operating thereon, the processor having operating thereon a design application having instructions configured for performing a method for designing a commercial or residential space comprising: selecting a space for design from a plurality of spaces, the plurality of spaces comprising a room, an apartment, a house, a garden, a yard, a commercial space, and combinations thereof; receiving information on the current design of the space via at least one of photos or video scanning of the space, light in the space, color(s) of the space, user preferences, measurements of the space, configuration and/or location of openings in the space, GPS location of the space or a designated GPS location (e.g., tropical location, mountain location, urban location), a neighborhood surrounding the location of the space, current items and/or other features of the space, sounds of and/or adjacent the space, and temperature and/or humidity of the space and/or of the GPS location of the space (or a selected GPS location); determining dimensions of the space; selecting a design scheme from a plurality of design schemes for re-designing the space; determining one or more products and/or services from a listing of products and/or services, the determined one or more products and/or services being associated with the design scheme; rendering a virtual map of the space according to the design scheme, the virtual map including a visual representations of at least one of the one or more determined products; and presenting the virtual map of the space to a user.

According to some embodiment of the present disclosure there is provided a system for designing a commercial or residential space comprising a computer system having at least one memory device and at least one processor(s) operating thereon, the at least one processor(s) having operating thereon a design application having instructions configured for performing a method for designing a commercial or residential space comprising: selecting a space for design from a plurality of spaces, the plurality of spaces comprising a room, an apartment, a house, a garden, a yard, a commercial space, and combinations thereof; receiving information on the current design of the space via at least one of photos or video scanning of the space, light in the space, color(s) of the space, user preferences, measurements of the space, configuration and/or location of openings in the space, GPS location of the space or a designated GPS location, a neighborhood surrounding the space, current items and/or other features of the space, sounds of and/or adjacent the space, and temperature and/or humidity of the space and/or of the GPS location of the space (or a designated GPS location); determining dimensions of the space; selecting a design scheme from a plurality of design schemes for re-designing the space; determining one or more products and/or services from a listing of products and/or services, the determined one or more products and/or services being associated with the design scheme; rendering a virtual map of the space according to the design scheme, the virtual map including a visual representations of at least one of the one or more determined products; and presenting the virtual map of the space to a user.

In some embodiments, the instructions are further configured for rendering a virtual map of the current design of the space and/or presenting the virtual map of the current design of the space. Each of the one or more products may be associated with a predetermined supplier. Each of the one or more services may be associated with a predetermined service provider. The predetermined supplier may be located within predetermined distance from the GPS location of the space or within a predetermined distance of another GPS location (e.g., within a predetermined distance from a contractor or designer's home location).

In some embodiments, the instructions may be further configured for receiving user input to select at least one of the one or more products and/or services to purchase and/or hire. The instructions may be further configured for receiving user input for ordering the selected at least one product from the corresponding predetermined supplier. The instructions may be further configured for receiving user input for ordering the selected at least one service from the corresponding predetermined provider thereof. At least one of the determined products and/or services may correspond to promoted products and services.

In some embodiments, presenting the virtual map comprises a virtual tour.

In some embodiments, the system and method may further comprise projecting means for projecting at least a portion of the virtual map onto a wall of the space, wherein the projected portion of the virtual map corresponds to the wall of the space. The system may further comprise three-dimensional (3D) visor/glasses for presenting the virtual map. The system may further comprise sensors for sensing hand gestures of the user so as to capture the gestures and presenting them with the virtual map via the 3D visor.

In some embodiments, the computer system is selected from the group consisting of: a mobile computer device, a desktop computer device, a server computer device, and combinations thereof. At least one processor may comprise a plurality of processors. The plurality of processors may comprise at least one mobile device processor. The plurality of processors may comprise at least one mobile device processor and at least one server processor, and wherein the processors are in communication via at least one of a wired and wireless connection.

At least a portion of the instructions may be configured to operate on the server processor. At least one mobile processor may comprise a smartphone.

According to some embodiment of the present disclosure there is provided a method for designing a commercial or residential space via a design application operating on a mobile device, the method comprising: activating the design application on the mobile device; creating a connection between the design application and an algorithm running on a communication network; selecting a space for design from a plurality of spaces, the plurality of spaces comprising a room, an apartment, a house, a garden, a yard, a commercial space, and combinations thereof; selecting a designer from a plurality of designers stored on a least one database, selecting a design scheme from a plurality of design schemes associated with the selected designer, for re-designing the space, wherein the plurality of design schemes are stored on at least one database; providing information manually by user input, or automatically by using sensors on the mobile device, to the communication network regarding the current design of the space via at least one of photos or video scanning of the space, light in the space, color(s) of the space, user preferences, measurements of the space, configuration and/or location of openings in the space, GPS location of the space or a designated GPS location (e.g., a tropical location, a mountain location, an urban location), a neighborhood surrounding the space, current items and/or other features of the space, sounds of and/or adjacent the space, and temperature and/or humidity of the space and/or of the GPS location of the space or a designed GPS location; determining dimensions of the space on the mobile device or the communication network by using the information provided from the mobile device; using the algorithm for rendering a virtual map of the space according to the design scheme, the virtual map including a visual representations of at least one of the one or more design schemes; the virtual map rendered based on pre-determined design rules and design templates applied to the data received from the mobile device and data which is stored on at least one database, and is associated with the selected designer; and presenting the virtual map of the space to the user.

In some embodiments, the method may further comprise determining one or more products and/or services from a listing of products and/or services stored on at least one database, the determined one or more products and/or services being associated with the design scheme.

In some embodiments, the method may further comprise rendering a virtual map of the space according to the design scheme, the virtual map including a visual representation of at least one of the one or more determined products.

### BRIEF DESCRIPTION OF THE DRAWINGS

The principles and operations of the systems, apparatuses and methods according to some embodiments of the present disclosure may be better understood with reference to the drawings, and the following description. The drawings are given for illustrative purposes only and are not meant to be limiting.

FIG. 1 is a schematic illustration of a system for designing a space, according to some embodiments of the present disclosure;

FIG. 2 is a schematic illustration of a system for designing a space, according to some embodiments of the present disclosure;

FIG. 3 is a schematic illustration of a system for designing a space, according to some embodiments of the present disclosure;

FIG. 4 is an exemplary flowchart of a method for designing a space, according to some embodiments of the present disclosure;

FIG. 5 is an exemplary flowchart of a method for designing a space, according to some embodiments of the present disclosure;

FIG. 6 is an exemplary flowchart of a method for designing a space, according to some embodiments of the present disclosure;

FIG. 7 is an exemplary schematic illustration of a system for designing a space, according to some embodiments of the present disclosure; and

FIG. 8 illustrates an exemplary system, according to some embodiments of the present disclosure.

### DETAILED DESCRIPTION

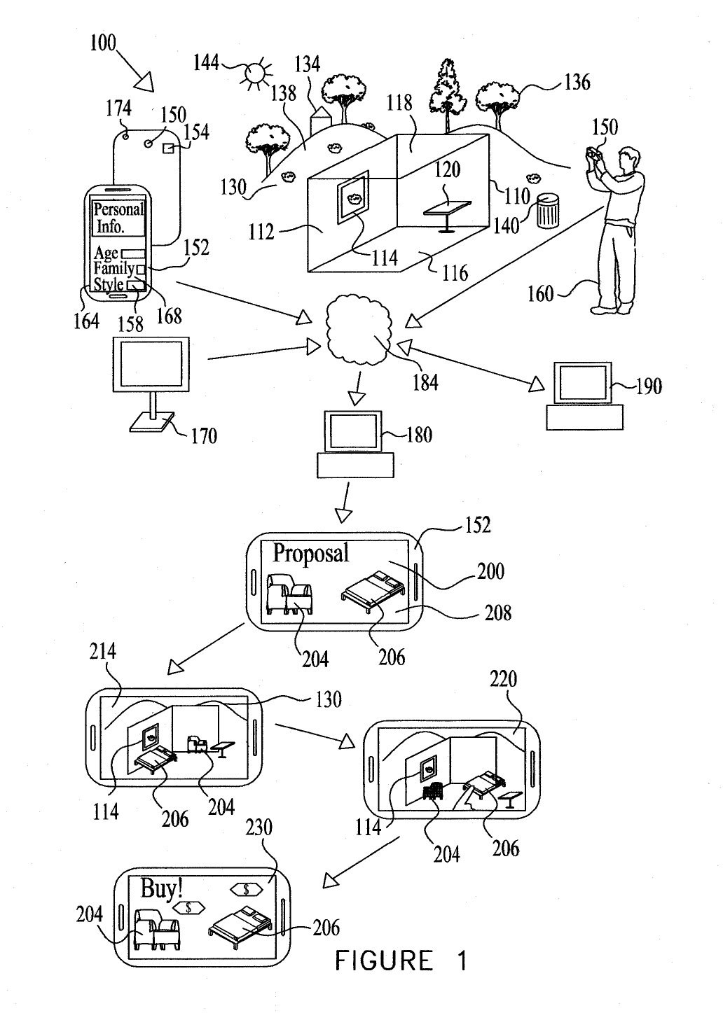

FIG. 1 is a schematic illustration of a system 100 for designing a space 110, according to some embodiments of the present disclosure. The space 110 may comprise a residential space, a room, an area within a room, an apartment, a building, a house, a garden, a yard, a commercial space or any other type of space that can be designed.

The system 100 may be configured to receive information on the current design of the space 110 in any suitable manner. The current design information may include information relating to the structure of the space 110, such as the space dimensions, measurements of the space 110, configuration and/or location of openings in the space 110, such as doors and window 114, form, such as the number of walls 112 and angles thereof, number of windows 114 and location of the window relative to the wall 114 or other products, (e.g. furniture, rugs) in the space 110, for example.

The current design information may include information relating to the decoration of the space 110, such as the colors and textures of the wall 112, floors 116 and ceiling 118. The current design information may include information relating to features and products 120 placed within the space 110. The products 120 generally include products 120 which are not the structure of the space 110. In a non-limiting example, the products 120 may include furniture, rugs, curtains and light fixtures.

The current design information may include infrastructure-related information, such as plumbing, air-conditioning, heating, and electricity, their types and placement within the space 110.

The current design information may include information relating to the exterior of the space 110, such as the external walls, façade of the space 110. In some embodiments, the exterior of the space 110 may be the exterior of a house or building wherein the space 110 is located.

The current design information may include information relating to the environmental surroundings 130 of the space 110. The surroundings information may include the type of surroundings, such as urban or nonurban, a neighborhood surrounding the space 110, objects and landscape in the vicinity of the space 110, such as houses 134, trees 136, mountains 138, and garbage cans 140, for example.

The current design information may include information relating to a geographical location of the space 110, such as the GPS location of the address of the space 110 or a designed GPS location (e.g., a tropical location, a mountain location, an urban location), the position of the space 110 in relation to the sun 144 affecting the lighting and the solar radiation within and out of the space 110 or the magnetic orientation of the space 110. The information relating to the geographical location of the space 110 may be used to derive information relating to weather and seasonal changes affecting the space 110. The current design information may include information relating to temperature and/or humidity of the space 110 and/or of the GPS location of the space 110 (and/or selected GPS location).

The current design information may include information relating to sounds of and/or adjacent the space 110, such as natural sounds from a river, winds or industrial sounds from a nearby factory or degree of noise pollution entering the space 110, such as via window 114.

The current design information may include information relating to user preferences, such as a list of desired products, the products style and color.

In some embodiments, the current design information may include information relating to user preferences may include selection by the user 160 of a designer, design house and/or architect from a plurality of designers, design houses and/or architects stored on a least one database. The designer, design house and/or architect is collectively referred to as a “designer” or “designer style”.

The current design information may be provided to the system 100 in any suitable manner. In some embodiments an imaging module 150 may be used to image the space 110 and/or its surroundings 130. The imaging module 150 may comprise a mobile device 152 equipped with a camera (shown on a back panel of the mobile device 152). The imaging module 150 may include a camera, a video machine or a three-dimensional (3D) visor/glasses, such as GOOGLE GLASS® or any other suitable imaging mechanism. The captured image may be a two dimensional image (2D), a three dimensional image (3D) and/or a video or movie of the space 110 or any other image.

The image of the space 110 and/or its surrounding 130 may be used to derive any current design information. For example, the imaging module may capture information relating to the structure of the space, such as the dimensions of the space 110, information relating to the decoration of the space 110. The imaging module may capture information relating to the infrastructure of the space 110, such as by detecting electrical outlets, air-conditioning vents and/or piping, for example. The system 110 (such as by the server module further described) may be configured to process the detected image of the electrical outlets, for example, and to accordingly identify the infrastructure layout (such as the layout of the electrical wiring with the space 110) and any other information related to the infrastructure.

In some embodiments a sound module 154 may be used to capture information relating to sounds of and/or adjacent the space 110. The sound module 154 may include an audio recorder within the mobile device 150, a microphone, a speaker, separate audio recorder and/or a three-dimensional (3D) visor/glasses.

In some embodiments an input module 158 may be configured for a user 160 to input information, such as the current design information into any suitable device. The input module 158 may include an input device, which may be included in a user machine 164. The user machine 164 may comprise any suitable means for communicating with a computing system. The user machine may comprise a computer, a server, an electronic device, a workstation, a desktop, a laptop, a notebook computer, a personal digital assistant (PDA), a smart phone the mobile device 152, and/or a three-dimensional (3D) visor/glasses, for example. The user machine 164 may comprise a plurality of machines.

The user machine 164 may comprise any suitable user input device including the input module 158 for allowing input of information into the computing system. The input device may comprise a click wheel or mouse, keyboard, scanner, pointing device, touch screen, recorder or microphone, for example. The user machine 164 may comprise any suitable user output module 168 for providing information to a user, typically a monitor, screen or display.

The input module 158 may be configured to allow the user to enter information in any suitable manner. For example, the user 160 may enter the information by selecting from a predetermined menu, listing a plurality of information options. In another example, the user 160 may enter the information by answering a questionnaire which guides the user 160 to enter the information. In another example, the user 160 may enter the information by use of free text or voice instructions, such as entering the user's special requests relating to the design. In some embodiments, the input module 158 may be configured to retrieve information from another database or a user machine 170, which may be configured to provide information, such as the current design information, user information and/or product and/or service information, described herein.

In some embodiments a gesture sensing module may be used to provide the system 100 with the current design information. The gesture sensing module may include sensors 174 provided on the user machine 164 for detecting gestures made by the user 160. The gestures may be made by the body of the user 160 (or any other human besides the user 160).

The sensors 174 may also be configured for detecting other current design information, such as sounds, images, temperature or humidity of the space 110 or the surroundings 130, for example.

In some embodiments, one or more GPS modules and/or map modules may be used to provide the information relating to a geographical location of the space 110 and/or the surroundings 130, as well as information on other geographical locations (e.g., tropical, mountainous, urban). The GPS modules and map modules may be facilitated by the user machine 164, such as the mobile device 152, or by any other user machine.

The system 100 may also be configured to receive any information related to the user 160. The user information may include user design preferences, a budget limit or range, a time frame for designing the space 110, family status, family size, age, user interests, user hobbies and user lifestyle.

The user information may be provided in any suitable manner. For example, the user information may be entered by the user 160 into the input module 158 of the user machine 164 by any suitable means, such as manually or by voice recording, for example. In some embodiments, the system 100 may include a feature allowing retrieval of user information from the user's social networks, personal files and/or public profile information. For example, user lifestyle, interests and hobbies may be obtained from the user's social networks.

The system 100 may also be configured to receive any information related to a product and/or service of interest. The information related to the product of interest may include a product of interest that the user 160 desires, such as a desired bed or chair, for example. The information related to the service of interest may include the service of interest that the user 160 desires, such as carpentering, for example. In some embodiments, the user 160 may provide the system 100 with the information related to a product and/or service of interest, such as by use of the input module 158. In some embodiments, the information related to a product and/or service of interest may be provided to the system 100 by the database or user machine 170.

The provided information, such as the current design information, user information and/or product and/or service information, may be transferred from any one of the user 160, user machine 164 (including for example, the mobile device 152) and the database or user machine 170, to a computing system 180.

The information may be transferred to the computing system 180 in any suitable manner, such as via a communication module, configured for transferring information from and to the user 160, user machine 164 or the database or user machine 170 and between the various modules (described herein, such as the imaging module 150, sound module 154, GPS modules and map modules or gesture sensing module, for example). The communication module may employ any means of communication, which may include in a non-limiting example, cellular or WiFi communication, acoustic, Radio Frequency (RF), infrared or other wireless communication. The communication module may comprise wired media such as twisted pair, coaxial cable, cables, fiber optics, wave guides, Ethernet or USB or any other wired media.

The transfer of the information via the communication module to the computing system 180 may be performed in any suitable manner, such as by a communication network 184 and/or a remote computing device. The communication network 184 may include a cloud computing service (also referred to as a cloud) having a cloud server and cloud storage in communication with a portal e.g., web portal) for receiving/transmitting content. The communication network 184 may comprise a local area network (“LAN”), a wide area network (“WAN”), and the Internet to allow information transfer thereby.

The computing system 180 may comprise a computer system or may be a component in a computer system with additional computer devices. The computer system may comprise at least one memory device and at least one processor(s) operating thereon. The processor(s) may be configured for performing the method for designing the space 110 as described herein.

The system 100 may comprise a server module, which may be configured to host at least a portion of a database and software required to perform the various tasks described herein, such as receiving the information from the user 160, user machine 164 or the database or user machine 170 and providing further data or information thereto.

The server module may be configured for providing the user 160 with a tool and method for designing the space 110. The tool and method may include providing the user 160 with a design scheme from a plurality of design schemes for re-designing the space 110, wherein the plurality of designs are stored on at least one database. The user 160 may select the design scheme from a plurality of design schemes for re-designing the space 110. The plurality of designs may be stored on at least one database, such as the computing system 180 and/or a remote database 190.

In some embodiments, the user 160 may select a designer from a plurality of designers stored on a least one database. A design scheme may be associated with the selected designer. The design scheme may include a layout of the structure of the space 110 and the selection and arrangement of the products within the space 110. The design scheme may reflect the style and design genre of the selected designer. In some embodiments, a plurality of proposals for products and/or services may be provided to the user 160. The proposals may match the design scheme. The system 100 may propose a plurality of proposals to the user 160 in accordance with the design scheme and the user 160 may select at least one of the plurality of proposals.

Where the space 110 is previously designed, the design scheme may be used for re-designing the space 110. When the space 110 is still unbuilt, the design scheme may be used for first designing the space 110.

The proposals and/or design scheme may be provided to the user 160 in real time or later in time to the user 160 for visualization, manipulation and/or ordering.

In some embodiments, the design scheme may include proposals or recommendations for a single or plurality of products or a single or plurality of services, or any other matter relating to designing the space 110. The design scheme may include proposals or recommendations for an arrangement of the products within the space 110.

The design scheme may include proposals (i.e. recommendations) for structuring the space 110, such as placement of the walls 112 or windows 114 within the space 110 and may also include the arrangement of the space structure relative to the products, such as arrangement of a bed relative to a window 114.

The design scheme may include proposals for infrastructure of the space 110, such as plumbing, air-conditioning, heating and electricity, their types and arrangement within the space 110.

In some embodiments, the design scheme may include proposals for the exterior of the space 110, such as the external walls, façade of the space 110 as well as landscaping, gardening or outdoor products (e.g. outdoor furniture, mailbox, garbage disposal).

The system 100 may base the proposals on any relevant information. In some embodiments, the system 100 may base the proposals on at least one of the current design information, user information and/or product and/or service information.

In a non-limiting example, the product the user wishes to purchase is a bed. The bed should be of a predetermined dimension for allowing the bed to appropriately be arranged within the space 110. The server module may generate a proposal of a bed of a selected dimension. The bed dimension may be based on one or many of the following considerations derived from the current design information. Such considerations derived from the current design information may include the dimensions of the space 110, which may be provided to the system 100 via the imaging module 150. The system 100 may be configured to translate the image provided by the imaging module 150 to physical dimensions by any suitable method. The bed dimensions may be selected to appropriately fit the dimensions of the space 110.

Another consideration derived from the current design information may include the images captured by the imaging module 150 of the surroundings 130. For example, whereupon the captured image from the window 114 is scenic the system 100 may consider placing the bed in proximity to the window 114. Additionally, the system 100 may also consider other information, such as user information. For example, the user information may include the user's preference for scenic surroundings 130.

Another consideration derived from the current design information may include the sounds of the surroundings 130 captured by the sound module 154. For example, whereupon the captured sound from an area of the space 110, such as from a left-sided wall, for example, is found to be clangorous, such as from a nearby industrial zone, the system 100 may consider placing the bed away from the clangorous portion of the space 110. Accordingly the system 100 may propose a bed with dimensions that may fit another, quieter area in the space 110.

Another consideration derived from the current design information may include the geographical location of the space 110 (or information on another GPS location) which may be provided by the GPS modules and/or map modules. The server module may be configured to retrieve weather patterns and/or climate data of the geographical location. Based on the retrieved weather patterns, the type of dressing of the window 114 may be selected to as to be compatible with the local weather. For example, whereupon the retrieved weather pattern is relatively cold, the system 100 may propose a window dressing that insulates the space 110 from the surroundings 130.

In some embodiments, the system 100 may base the proposals on the user information. For example, whereupon the product is a bed, the server module may generate a proposal of a bed based on the user information, such as user preferences regarding color, style, texture, size and age(s) of the user 160 (and other occupants of the space 110) and budget range, for example.

In some embodiments, the system 100 may be configured to consider a plurality of received information, such as the current design information relating to the surrounding sounds along with the user preferences related to the color of the bed.

In some embodiments, the system 100 may be configured to base the proposals on design rules. The design rule may include any suitable set of rules or guidelines for designing the space 110. In some embodiments, the design rules may include basic rules. Such basic design rules may be rules typically practiced by most designers and architects. An exemplary basic design rule may be to refrain from placing the bed near a door. In some embodiments, the design rules may include preferable design rules. An exemplary preferable design rule may be to place a television in front of the bed. In some embodiments, the design rule may include rules relating to the arrangement of products within the space 110. An exemplary arrangement design rule may be to ensure a closet door is at least 80 cm afar from a door opening, or a space between two beds in a children's bedroom should be at least 60 cm wide, or a bed or closet should not block a window 114.

In some embodiments, the design rules may include architect or designer rules (referred to as “architect design rules” and may include a designer design rules). The architect design rules may include rules determined by a specific architect, designer or designer house. These architect design rules may reflect the design genre. An exemplary architect design rule may be to prefer use of selected colors in the space 110, or to prefer use of a large product in the space 110 to serve as a focal point, or to prefer use of certain geometrical patterns.

In some embodiments, in accordance with the architect design rules, the architect may select a supplier of products or services or providers thereof that operate in accordance with the architect design rules. The system 100 may be configured to propose products and/or services of these selected suppliers of products or services. It is noted that the selected supplier of products or services may change over time and the designer may switch from one supplier to another. Accordingly, in some embodiments, the system 100 may be configured to be updated with a current selected supplier pool. In some embodiments, the system 100 may be configured to receive updated information from the remote computing system 190 comprising a server or database. For example, the remote database may be configured to receive the updated supplier pool from the designer.

The remote database 190 may communicate with other remote servers, databases and/or computing devices.

The communication between the computing system 180 and the remote computing system 190 may be in any suitable manner, such as by the communication network 184.

The system 100 may process the information and generate the proposals and/or the design scheme in any suitable manner. For example, system 100 may be configured to retrieve existing design schemes from images and/or design catalogues. The system 100 may display the existing design schemes to allow the user 160 to select a design scheme therefrom.

In some embodiments, the system 100 may process the information and generate the proposals and/or the design scheme by use of a design algorithm.

The design algorithm may be embedded into a processor of the computing system 180 or remote server 190 or any server module. The server module may receive the information captured by the user 160. The design algorithm may be configured to analyze the information and apply the design rules for generating the proposals and/or the design scheme.

For example, the design algorithm may be configured to retrieve existing design schemes from images and/or design catalogues and select a single or multiplicity of proposals and/or the design schemes based on the design rules and received information.

In some embodiments, the information may be provided by the user 160, for example, by the user 160 imaging the space 110 using a camera. In some embodiments, the design algorithm may operate automatically without user intervention or at least some actions performed by the design algorithm may be performed automatically without user intervention. For example, following receipt of the information (e.g. the current design information, user information and/or product and/or service information) the design algorithm may retrieve existing design schemes from other servers, such as remote servers 190, and based on the information and design rules, select the proposals and/or the design scheme. For another example, the design algorithm may be configured to receive information, such as the image of the space 110 and sounds of the space 110 and its surroundings 130, by sensors 174 on the user device 164, such as the mobile device 152.

In a non-limiting example, the information may include as part of the user preferences, a selected specific designer selected by the user 160. In another example, the design algorithm may be configured to identify without the explicit user input, an appropriate designer which best matches the received information.

The design algorithm may utilize the design rules to generate the proposals and/or design scheme.

In some embodiments, the proposed products or services may be presented to the user 160 without supplier information. The user 160 may thereafter locate a supplier. In some embodiments, a designer may be selected by the user 160 in the user information input. The design algorithm may present the user with products or services matching the design rules of the selected designer and the user 160 may locate the products or services online or by any other suitable means. In some embodiments, the selected designer may be located and may offer proposals of products or services either provided by himself or by another supplier.

In some embodiments, the proposals and/or the design scheme may include products and/or services of a single or plurality of suppliers. In some embodiments, the selection of the suppliers by the design algorithm may be performed based on at least one of the following: The information and design rules. For example, following selection of a plurality of similar products provided by various suppliers, the design algorithm may propose to the user 160 a product provided by a supplier fitting within the budget limit provided by the user in the user information input. In another example, a product may be selected to match with the design rules associated with the design scheme of the selected designer; A designer may be selected by the user 160 or the designer may be proposed by the system 100. The designer may propose selected suppliers or a plurality of suppliers and the design algorithm may be configured to further select a smaller group from the plurality of suppliers based on the information provided by the user 160; A ranking procedure may rank some products or services from suppliers. In some embodiments, ranking can be affected by the system 100 selection of promoted products and/or services. In a non-limiting example, the promoted products and/or services may be selected according to amounts paid by the supplier to promote their products and/or services.

The design algorithm may employ any suitable methods for selecting the proposals and/or design scheme. In a non-limiting example, Constraint Satisfaction Problem (CPS) algorithms and methods may be used, such as for example, for basic design rules, or for all design rules, such as wherein the space 110 is relatively small. In a non-limiting example, general optimizations algorithms, such as linear programming, or parameters optimization methods, may be used, such as for preferable design rules, or for any of the design rules.

The proposals and/or design scheme may be provided to the user 160 on the output module 168 in any suitable manner. In some embodiments, the system 100 may comprise a visualization module configured for displaying the proposals and/or design scheme. In some embodiments, an image and/or textual description of the proposals and/or design scheme may be displayed. In some embodiments, a scan, two dimensional image (2D), a three dimensional image (3D) and/or a video, video scanning or movie of the space 110 may be displayed. In some embodiments, the visualization module may be configured for displaying to the user 160 the proposed proposals and/or design scheme and may render a virtual map of the space 110 according to the provided proposals and/or design scheme. The virtual map may include a visual representation of at least one of the one or more products of the proposals and/or design schemes. In some embodiments, the visualization module may be configured for displaying to the user 160 the proposed proposals and/or design scheme in 3D augmented reality, virtual reality or a combination of both augmented and virtual reality. The display may include proportional presentations of the products with respect to the actual size of the space 110. In some embodiments, the virtual map may comprise projecting at least a portion of the virtual map onto the wall 112 of the space 110, wherein the projected portion of the virtual map corresponds to the wall 112 of the space 110.

In some embodiments, a virtual display including a virtual map of the space 110 may be displayed. The virtual map may be configured to allow the user to take a “virtual tour” wherein the display moves.

In some embodiments, the system 100 may render a first virtual map of the space 110 following selecting the space 110 to be designed, and receipt of current design information, such as the image of the space 110 and sounds of the space 110 and it surroundings 130, and receipt of the dimensions of the space 110. The first virtual map of the space 110 may optionally be presented to the user 160. The design scheme may be selected from a plurality of design schemes stored on at least one database. The system 100 may access a predetermined list of products and/or services available from a listing of predetermined suppliers thereof stored on at least one database, wherein each of the products are associated with one or more specific design schemes of the plurality of design schemes. Thereafter, one or more products and/or services for the space 110 may be determined according to the selected design scheme. The one or more products and/or services may be associated with predetermined suppliers and/or providers thereof, wherein each of the products and/or service is associated with one or more of the design schemes of the plurality of design schemes. The system 100 may render a second virtual map of a re-design of the space according to the first scheme which includes visual representations of at least one of the one or more determined products. The second virtual map of the space 110 may be presented to the user 160. The user may select at least one of the one or more products and/or services to purchase/hire and then the user may purchase and/or hire the selected at least one product and/or services from the corresponding predetermined supplier/provider thereof.

In some embodiments, the user 160 may upload a picture comprising images from the virtual map or may upload the virtual map. The user 160 may rate the picture or virtual map and provide comments as to his opinion of the picture or virtual map. The user 160 may share the picture or virtual map with other users via the communication network 184. The other users may rate the picture or virtual map and provide further feedback and opinion related to the uploaded picture or virtual map.

In some embodiments, the proposal and/or design scheme may be displayed separately, without showing an image of the space 110, such as shown in image 200, showing a proposed chair 204 and bed 206 on a screen 208 of the mobile device 152.

In some embodiments, such as shown in image 214, the proposal and/or design scheme may be displayed together with the image of the space 110. The proposal and/or design scheme may be displayed arranged according to the information and/or design rules received by the system 100 (and may be generated by the design algorithm), for example, the bed 206 is arranged beneath the window 114 and the chair 204 is arranged near an adjacent wall 112. In some embodiments, the current design information, such as sounds, surrounding 130 and lighting, for example may be included in the display.

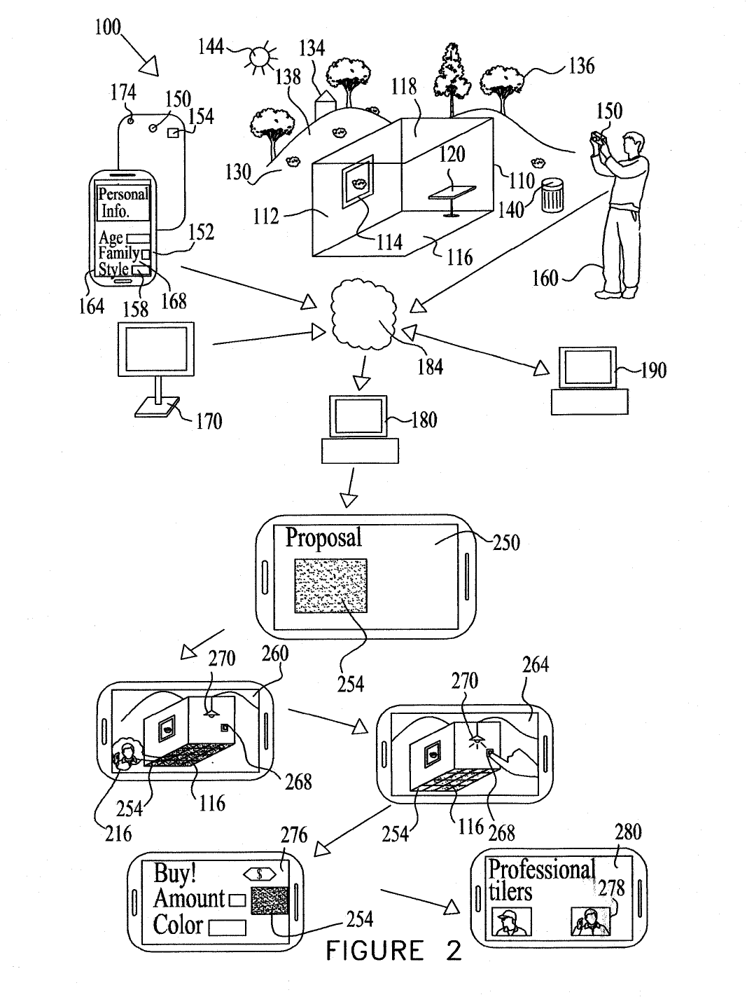

In some embodiments, the image 200 may be obviated and the system 100 may display the image (e.g. as a virtual map) by filing the space 110 with a plurality of products associated with the selected design scheme. Thereafter the products may be shown in various colors, textures and/or arrangements within the space 110. Additionally, services may be shown in any suitable manner for designing the space 110 in accordance with the provided design scheme, such as by adding an insert 216 near the relevant product as shown in image 260 in FIG. 2. The product and/or services may be selected by the design algorithm based on the selected design scheme, design rules and/or the received information.

In some embodiments, the system 100 may alternately present the virtual map of the space 110 according to the design scheme and present a virtual map of the current design of the space based on the user input.

In some embodiments, the gesture sensing module may allow the user to move or otherwise manipulate elements of the display, such as seen at image 220 wherein the user may rearrange the bed 206 and chair 204, for example. In some embodiments, the system 100 may allow the user 160 to manipulate elements related to the current design information, such as for example, opening and or closing the window 114 to hear the change in the sounds coming from the surroundings 130. Another example may be to change the season of the year or time of day to see the effect of the changed sunlight on the lighting of the space 110.

In some embodiments, the system 100 may allow manipulation of decoration features of the proposal and/or design scheme. For example, the user 160 may select different colors and patterns for the chair 204, as seen in image 220.

Turning to image 230, it is seen that the system 100 may allow the user 160 to order and/or purchase the proposed products and/or services, such as the bed 206 and chair 204, for example. The purchasing may be performed online or offline.

In some embodiments, the system 100 may use the user information or GPS location of the space 110 (or GPS information of a designer or contractor) to propose a supplier located relatively close to the space 110 or any other user related location or the supplier may be located within a predetermined distance from the selected GPS location.

In some embodiments, the system 100 may be configured to allocate a commission of the purchase to a manager of the system 100 or any other suitable entity. In some embodiments, the commission may be paid by the user 160, the supplier or both and/or any other entity.

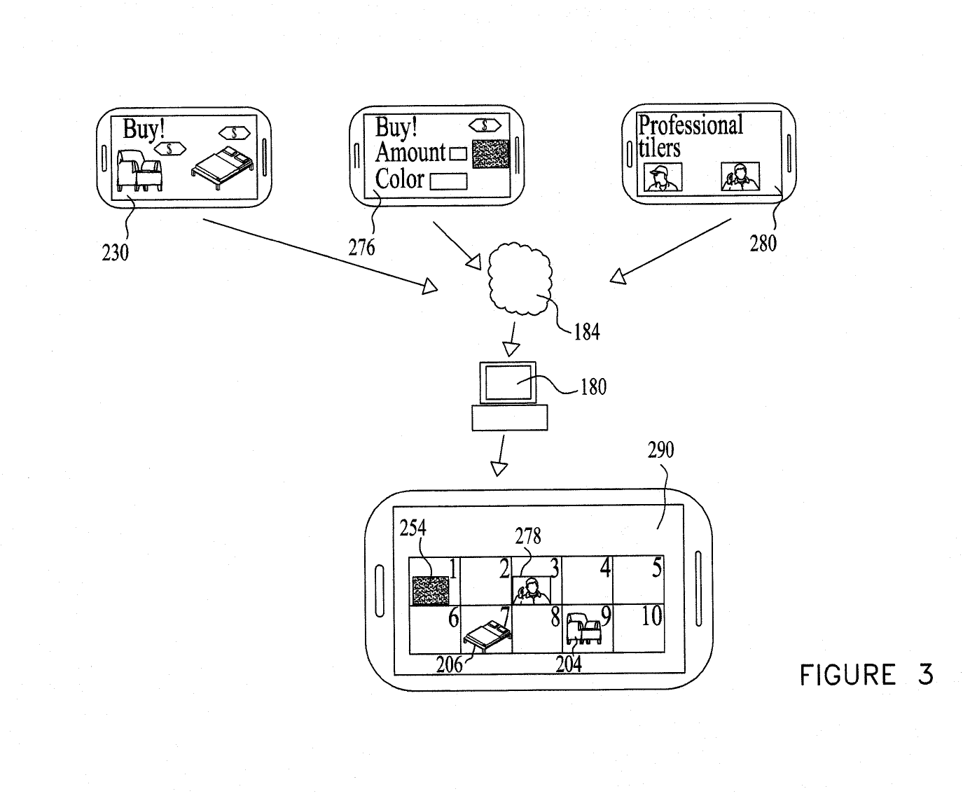

Further examples of services and schedule coordination are described in reference to FIGS. 2 and 3.

FIG. 2, is a schematic illustration of the system 100 for designing the space 110, according to some embodiments of the present disclosure. The user 160 may provide the information, including least one of the current design information, user information and/or product and/or service information via the communication network 184 to a computing system 180 for generating proposals and/or design schemes, as described in reference to FIG. 1.

In the exemplary embodiment of FIG. 2, as seen in image 250, a proposal may include a sample of a tile 254 for the flooring 116. The tile 254 may be displayed with a selected color, size and/or texture based on the provided information and/or the design rules.

In some embodiments, such as shown in image 260, the proposal and/or design scheme may be displayed together with an image of the space 110. The proposal and/or design scheme may be displayed arranged according to the information received by the server module and/or design rules (and may be generated by the design algorithm), for example, the floor 116 may be shown covered by a plurality of tiles 254. In some embodiments, the current design information, such as sounds, surrounding 130, lighting, for example may be included in the display.

In some embodiments, a virtual display including a virtual map of the space 110 may be displayed. The virtual map may be configured to allow the user to take a “virtual tour” wherein the display moves.

In some embodiments, the image 250 may be obviated and the system 100 may display the image (e.g. as a virtual map) by filling the space 110 with a plurality of products associated with the selected design scheme. Thereafter the products may be shown in various colors, textures and/or arrangements within the space 110. Additionally, services may be shown in any suitable manner for designing the space 110 in accordance with the provided design scheme, such as by adding the insert 216 near the relevant product as shown in image 260, where a professional tiler is shown as a service provider for installing the tiles 254. The product and/or services may be selected by the design algorithm.

In some embodiments, the gesture sensing module may allow the user to move or otherwise manipulate elements of the display, such as seen in image 264 wherein the user may turn on a light switch 268 which virtually turns on a light fixture 270, which may be set to a predetermined light intensity. The user 160 may visualize the color and texture of the tiles 254 with the light turned on as seen in image 264, and compare with the image of the tiles 254 shown in image 260, while the light is off.

In some embodiments, the system 100 may allow manipulation of decoration features of the proposal and/or design scheme. For example, the user 160 may select different colors and patterns of the tiles 254 to be displayed.

Turning to image 276, it is seen that the system 100 may allow the user 160 to order and/or purchase the proposed products and/or services, such as the tiles 254, for example. The system 100 may be configured to calculate the number of tiles 254 required for covering the floor 116, based on the dimensions of the space 110 provided in the current design information. The purchasing may be performed online or offline

In some embodiments, the system 100 may use the user information or GPS location of the space 110 (or GPS location of a designated location) to propose a supplier located relatively close to the space 110 or any other user related location.

In some embodiments, the system 100 may further propose service providers 278, for performing a service related to the selected product, such professional tilers for laying the tiles 254 on the floor 116, as seen in image 280. In some embodiments, the proposal of the service providers may be performed in any suitable manner, such as the methods described herein, such as by the design algorithm, for example.

In some embodiments, the system 100 may provide proposal which may include service providers recommended as well as a proposal which includes their work costs and may further guaranty or qualify their performance. In some embodiments, the system 100 may access a service provider database at the computing system 180 and/or in the remote server 190. The service provider database may be ranked according to user feedback provided by other users and recommendations from other users or other input relates to the performance of the service providers.

In some embodiments, the system 100 may use the user information or GPS location of the space 110 (or GPS location of a designated location) to propose a supplier or a service provider located relatively close to the space 110 or any other user related location.

In some embodiments, the system 100 may be configured to allocate a commission of the purchase to a manager of the system 100 or any other suitable entity. In some embodiments, the commission may be paid by the user 160, the supplier or both and/or any other entity.

FIG. 3 is a schematic illustration of a system 100 for designing a space 110, according to some embodiments of the present disclosure. In some embodiments, the system 100 may be configured to manage a plurality of selections, such as purchases of products and ordering and hiring of services, performed by the user 160. In a non-limiting example, the purchase of the bed 206 and chair 204, as shown in image 230 of FIG. 1, the purchase of the tiles 254 shown in image 276 of FIG. 2 and the ordering of a tiler as shown in image 280 of FIG. 2, may be received by the computing system 180 via the communication network 184. The computing system 180 may be configured to process the plurality of selections in any suitable manner. For example, the computing system 180 may be allowed to access the calendar of the service provider and/or the product suppliers.

In another example, the computing system 180 may be configured to manage the schedule of the plurality of design related activities to ensure proper management of the design project. In a non-limiting example, project management may include ensuring the tiles 254 are supplied at the space 110, such as on the 1^{st} of the month, prior to arrival of the tilers, scheduled for the 3^{rd} of the month. Likewise, the project management may include ensuring the tiles are properly laid-out and the flooring is complete prior to supply of the bed 206 and chair 204, scheduled for the 7^{th} and 9^{th} of the month. The schedule may be displayed to the user 160, as seen in image 290, and may be further shared at least partially with the suppliers and service providers.

In some embodiments, the computing system 180 may be configured to access the calendar of the user 160, such as from a remote server 190 and incorporate the design project schedule with the user calendar. In some embodiments, the computing system 180 may request the user 160 to provide his schedule and/or a listing of convenient dates and time to allow the computing system 180 to schedule a design project.

In some embodiments, the computing system 180 may be configured to generate reminders of the design project schedule or activities, such as arrival of a service provider at the space 110. Alerts may also be generated in case there are schedule changes and/or conflict with the user calendar or a reminder or alert for any activity related to the design project management

In some embodiments, the system 100 may manage ordering of products, such as via mail or courier services.

In some embodiments, the system 100 may be configured to manage the payment from the user 160 to the service providers and/or product suppliers in any suitable manner, such as according to a predefined protocol. In a non-limiting example, the payment management protocol may dictate that full payment by the user 160 is made after the project is completed and positive user feedback is received. Such management can be for example achieved by transferring payments according the progress made in the project. Or in case of product purchase, payment may be made in installments, based on the timely supply of the products, and/or based on user satisfaction feedback.

In some embodiments, the system 100 may be configured to manage a degree of provision of information related to proposals and/or design schemes in any suitable manner. For example, in some embodiments, the user 160 may be allowed to access all information related to proposals and/or design schemes. In some embodiments, the information related to proposals and/or design schemes may be partially provided to the user 160, such as the supplier address of a selected product. Upon payment of a fee will the user 160 be allowed to receive the supplier information. In some embodiments, the system 100 may allow the user 160 to access information related to proposals and/or design schemes allowing the user 160 to inspect his selection, such as a selected product, in reality. In some embodiments, the system 100 may inform the supplier that the user 160 will arrive to inspect the product. In some embodiments the system 100 may register suppliers of products and/or services in a supplier database. The registered suppliers may be requested to provide discounts to users 160 purchasing products or services via the system 100. This may be used to promote use of the system 100 which will on the long run reduce supplier costs for holding inventory and exhibition rooms.

In some embodiments, the system 100 may be at least partially or fully performed by a design application on the mobile device 152. The design application may be configured to receive the information and manage the transfer of the information to the server module. The generated proposals and/or design scheme may be presented on the mobile device 152. The purchasing of the selected products and/or service providers and management of the design project and management of the payment may also be performed by the design application, as well as any other activity described herein.

In some embodiments, the design application may be configured to guide the user 160 to perform activities related to the design application, such as provide the information, select the desired products and/or services and purchasing thereof. Guidance of the user 160 may be performed in any suitable manner, such as by textual messages, requesting filling of blank spaces on the display of the mobile device 152, and/or by the use of audio instructions to instruct the user 160 to perform activities related to the design application.

In some embodiments, the system 100 may comprise a computer system having at least one memory device and at least one processor(s) operating thereon, the at least one processor(s) having operating thereon the design application having instructions configured for performing the method for designing the space 110, as described herein.

The examples described in reference to FIGS. 1-3 relate to design of an interior space 110. The system 100 may be configured for designing any suitable space. For example, the space 110 may include a plurality of rooms or a section in a building or house, a basic area plan or overall design of a house or building. In some embodiments, system 100 may be configured for designing the space 110 comprising an exterior portion of a house or building, such as the façade, or the landscape around the home or building, or a garden, or a yard. In some embodiments, system 100 may be configured for designing the space 110 comprising both the interior and exterior of a house or building. In some embodiments, system 100 may be configured for designing the space 110 comprising larger areas such as a plurality of building, large complex structures, such as malls, for example. In some embodiments, system 100 may be configured for designing the space 110 comprising a street, a town or a city and may be used for urban planning.

In some embodiments, system 100 may be configured for designing a space which is yet unbuilt. The current design information may include information related to the area designated for the designed space, such as GPS information and maps of a specific area. In some embodiments, existing floor plans of the space may be accessed and used by the system 100 for proving proposals and/or the design scheme.

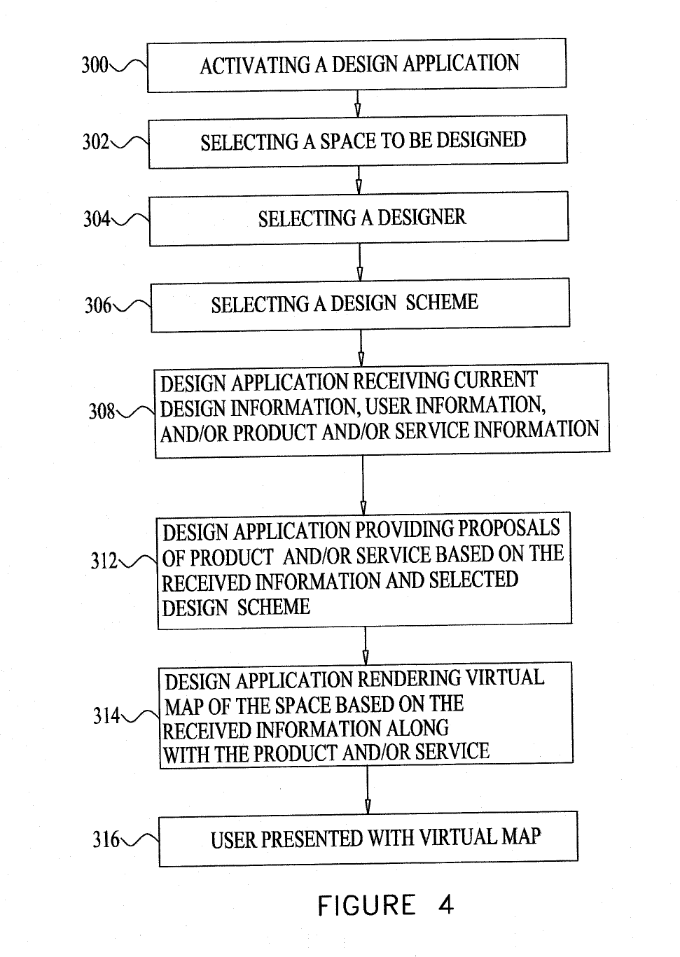

FIG. 4 is an exemplary flowchart of a method for designing a space. In the exemplary embodiment of FIG. 4 the system 100 is utilized at least partially by a design application. The design application may operate on a mobile device, such as device 152 shown in FIGS. 1-3. At step 300 the design application is activated. In some embodiments a connection between the design application and the design algorithm running on the communication network 184 may be established. In step 302 the space 110 to be design is selected. Step 302 may be performed after or before step 300. At step 304 a designer may be selected from a plurality of designers stored on a least one database. A plurality of design schemes may be displayed to the user 160 on the user device 164, such as on the mobile device 152. The user 160 may select one of the design schemes, as seen at step 306.

At step 308, the design application may be configured to receive information related to the design such as any one of: the current design information, user information and/or product and/or service information, as described in reference to FIGS. 1-3. The information may be provided in any suitable manner, as described in reference to FIGS. 1-3.

At step 312, the design application provides proposals of the product and/services based on the received information at step 308 and the selected design scheme at step 306.

At step 314 the design application may render a virtual map of the space 110 based on the received information in step 308 the selected design scheme at step 306 and may include the product and/or service proposed at step 312. The design application may render the virtual map by filling the space 110 with a plurality of products associated with the selected design scheme. Thereafter the products may be shown in various colors, textures and/or arrangements within the space 110. Additionally, services may be shown in any suitable manner for designing the space 110 in accordance with the provided design scheme. The product and/or services may be selected by the design algorithm based on the selected design scheme, design rules and/or the received information.

The design application may present the virtual map to the user 160, as seen in step 316.

The user 160 may purchase the selected product and/or hire the selected service. The design application may further manage the payment of the product and/service and/or may manage the supply and delivery of the product and/service and/or the schedule of the design project, as described in reference to FIGS. 1-3.

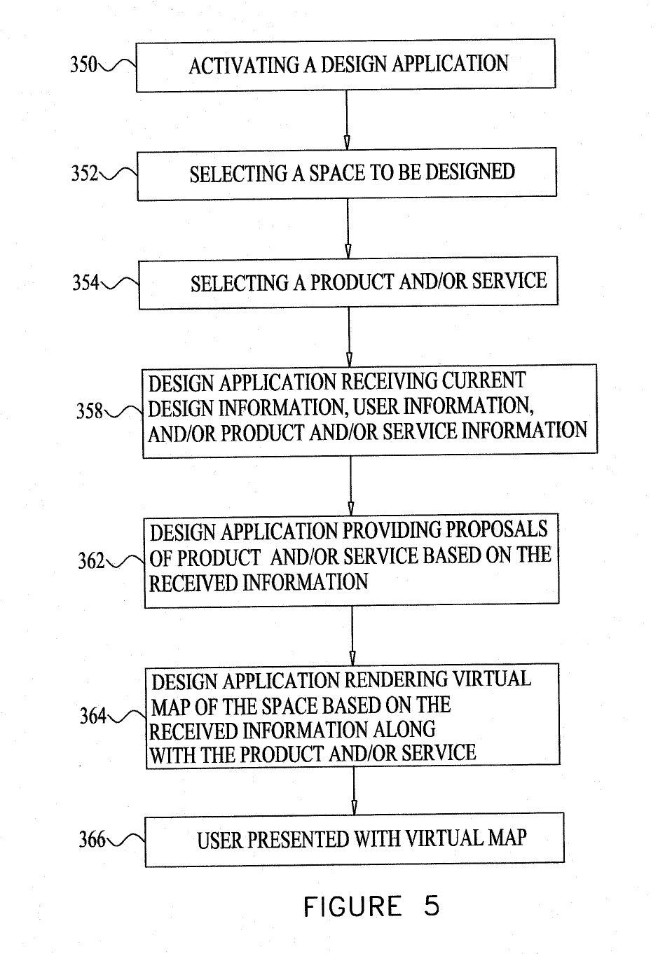

FIG. 5 is an exemplary flowchart of a method for designing a space. In the exemplary embodiment of FIG. 5 the system 100 is utilized at least partially by a design application. The design application may operate on a mobile device, such as device 152 shown in FIGS. 1-3. At step 350 the design application is activated. In some embodiments a connection between the design application and the design algorithm running on the communication network 184 may be established. In step 352 the space 110 to be design is selected. Step 352 may be performed after or before step 350. At step 354 a product and/or service may be selected for the design of the space 110. Step 354 may be performed before or after any one of steps 350 or 352.

At step 358, the design application may be configured to receive information related to the design such as by at least one of: the current design information, user information and/or product and/or service information, as described in reference to FIGS. 1-3. The information may be provided in any suitable manner, as described in reference to FIGS. 1-3.

At step 362, the design application provides proposals of the product and/services based on the received information at step 358.

At step 364 the design application may render a virtual map of the space 110 based on the received information in step 358 and may include the product and/or service proposed at step 362.

The design application may present the virtual map to the user 160, as seen in step 366.

The user 160 may purchase the selected product and/or hire the selected service. The design application may further manage the payment of the product and/service and/or may manage the supply and delivery of the product and/service and/or the schedule of the design project, as described in reference to FIGS. 1-3.

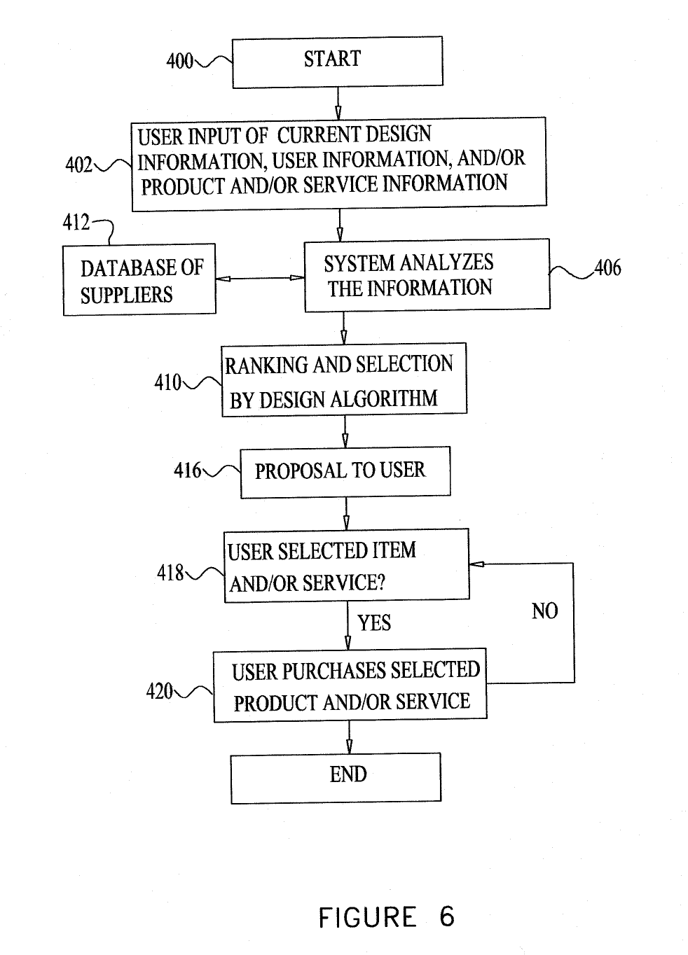

FIG. 6 is an exemplary flowchart of a method for designing a space. In FIG. 6 some features of the operation of the system 100 are shown. As seen at block 400 the system 100 is activated. At block 402, the user 160 provides information related to the design such as any one of: the current design information, user information,(which may also include selection of a designer) and/or product and/or service information, as described in reference to FIGS. 1-3. The information may be provided in any suitable manner, as described in reference to FIGS. 1-3.

At block 406 the system analyzes the received information at block 402, which may include use of the design algorithm including processes for selection of proposals of the products and/or services and the system may rank suppliers of the products and/or services, as seen at block 410. The analysis may include communication with a database of suppliers, as seen in block 412.

At block 416, the user 160 receives proposals for the products and/or services based on the analysis, selection and ranking of blocks 406 and 410.

At block 418 the system 100 inquires as to selection of the products and/or services by the user 160. If the selection was not made, the system 100 may provide further proposals, as shown in block 416. If the selection was made, the system 100 will guide the user 160 to purchasing the products and/or the services as seen in block 420. The system 100 may further manage the payment of the product and/service and/or may manage the supply and delivery of the product and/service and/or the schedule of the design project, as described in reference to FIGS. 1-3.

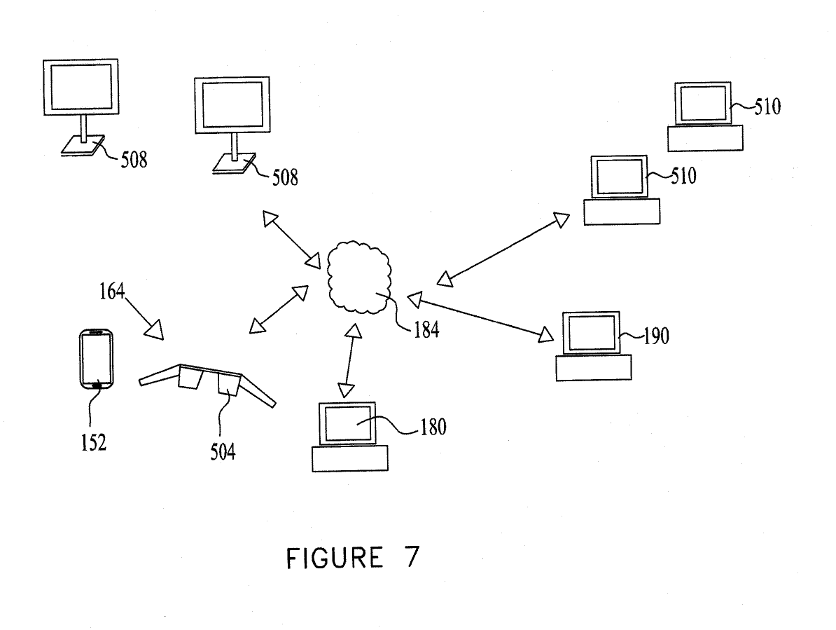

FIG. 7 is an exemplary schematic illustration of a system for designing a space 110. As seen in FIG. 7, the information (such as the current design information, user information and/or product and/or service information, as described in reference to FIGS. 1-3.) may be provided from one or a plurality of user machines 164, such as the mobile device 152 and a three-dimensional (3D) visor or glasses 504.

In some embodiments, more than one user can share images of the space 110 and/or products with two visors or glasses, and one user can make selections for the other user to view and provide his agreement of a proposed product and/or service, for example.

In some embodiments, the 3D visor or glasses 504 may be used for the display as well as some other modules, or all of the modules described herein (e.g. visualization module, sound module, etc.). In some embodiments, the system 100 may utilize the 3D visor or glasses 504 along with a device for gesture sensing. In some embodiments, the 3D visor or glasses 504 combine augmented reality display with virtual reality display in a way that the user 160 can switch between these displays or in a way that one visor is used for augmented reality while the other for virtual reality so the product's real colors can be appreciated by the user.

Further information and data may be transmitted to and from a plurality of supplier servers 508. The supplier servers 508 may store in a memory thereof or may retrieve from a remote location, (e.g. a cloud) information relating to the suppliers of the products and/or services. Further information and data may be transmitted to and from a plurality of designer servers 510. The designer servers may store the design rules and design schemes in a memory thereof or may retrieve from a remote location, (e.g. a cloud). The server module of the computing system 180 (FIG. 1) may mange the transmission of information via the communication network 184 to and from any one of the user machines 164, the supplier servers 508, designer servers 510 and any other related server or database, such as the remote computing system 190.

It is noted that the user 160 may include a person, more than one person, or a machine programmed with artificial human intelligence.

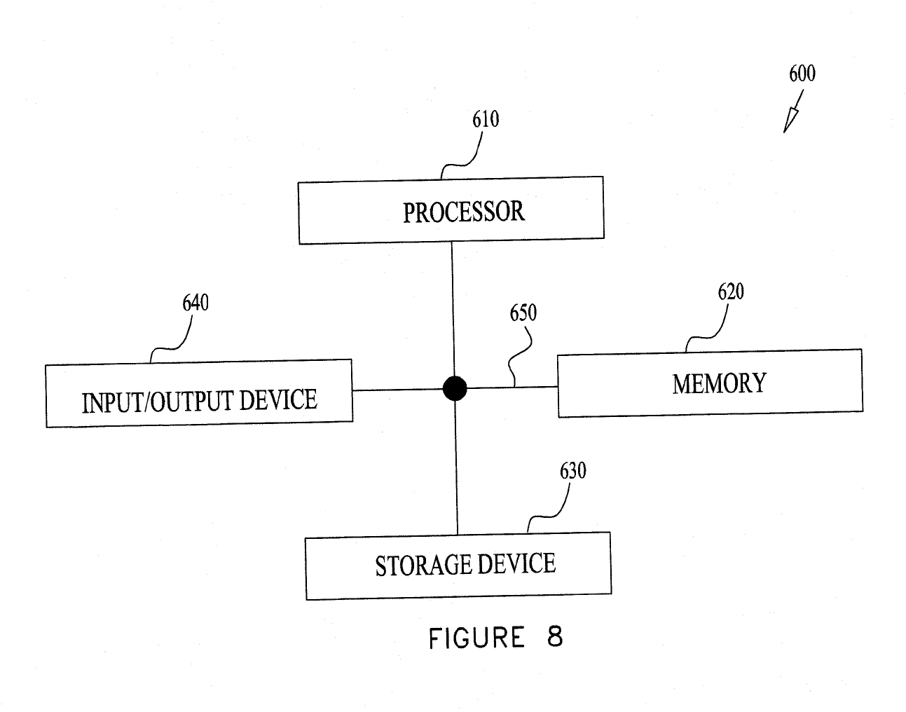

In some embodiments, the current subject matter can implement a computer-implemented system, a computer-implemented method, and/or a computer program product for the purposes of controlling various operations performed by one or more components of the system (e.g., such as system 100 described in FIGS. 1-5) and/or the entire system. Such exemplary computer-implemented system is illustrated in FIG. 8 as system 600. The system 600 can include a processor 610, a memory 620, a storage device 630, and an input/output device 640. Each of the components 610, 620, 630 and 640 can be interconnected using a system bus 650. The processor 610 can be configured to process instructions for execution within the system 600. In some implementations, the processor 610 can be a single-threaded processor. In alternate implementations, the processor 610 can be a multi-threaded processor. The processor 610 can be further configured to process instructions stored in the memory 620 or on the storage device 630, including receiving or sending information through the input/output device 640. The memory 620 can store information within the system 600. In some implementations, the memory 620 can be a computer-readable medium. In alternate implementations, the memory 620 can be a volatile memory unit. In yet some implementations, the memory 620 can be a non-volatile memory unit. The storage device 630 can be capable of providing mass storage for the system 600. In some embodiments, the storage device 630 can be a computer-readable medium. In alternate embodiments, the storage device 630 can be a floppy disk device, a hard disk device, an optical disk device, a tape device, non-volatile solid state memory, or any other type of storage device. The input/output device 640 can be configured to provide input/output operations for the system 600. In some embodiments, the input/output device 640 can include a keyboard and/or pointing device. In alternate embodiments, the input/output device 640 can include a display unit for displaying graphical user interfaces.

Various implementations of some of embodiments disclosed, in particular at least some of the processes discussed (or portions thereof), may be realized in digital electronic circuitry, integrated circuitry, specially configured ASICs (application specific integrated circuits), computer hardware, firmware, software, and/or combinations thereof. These various implementations, such as associated with the system 100 for designing a space and the components thereof, for example, may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Such computer programs (also known as programs, software, software applications or code) include machine instructions/code for a programmable processor, for example, and may be implemented in a high-level procedural and/or object-oriented programming language, and/or in assembly/machine language. As used herein, the term “machine-readable medium” refers to any computer program product, apparatus and/or device (e.g., non-transitory mediums including, for example, magnetic discs, optical disks, flash memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a LCD (liquid crystal display) monitor and the like) for displaying information to the user and a keyboard and/or a pointing device (e.g., a mouse or a trackball, touchscreen) by which the user may provide input to the computer. For example, this program can be stored, executed and operated by the dispensing unit, remote control, PC, laptop, smartphone, media player or personal data assistant (“PDA”). Other kinds of devices may be used to provide for interaction with a user as well. For example, feedback provided to the user may be any form of sensory feedback (e.g., visual feedback, auditory feedback, or tactile feedback), and input from the user may be received in any form, including acoustic, speech, or tactile input. Certain embodiments of the subject matter described herein may be implemented in a computing system and/or devices that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components.

The components of the system may be interconnected by any form or medium of digital data communication (e.g., a communication network). Examples of communication networks include a local area network (“LAN”), a wide area network (“WAN”), and the Internet. The computing system according to some such embodiments described above may include clients and servers. A client and server are generally remote from each other and typically interact through a communication network. The relationship of client and server arises by virtue of computer programs running on the respective computers and having a client-server relation to each other.

Any and all references to publications or other documents, including but not limited to, patents, patent applications, articles, webpages, books, etc., presented anywhere in the present application, are herein incorporated by reference in their entirety.

Example embodiments of the devices, systems and methods have been described herein. As may be noted elsewhere, these embodiments have been described for illustrative purposes only and are not limiting. Other embodiments are possible and are covered by the disclosure, which will be apparent from the teachings contained herein. Thus, the breadth and scope of the disclosure should not be limited by any of the above-described embodiments but should be defined only in accordance with claims supported by the present disclosure and their equivalents. Moreover, embodiments of the subject disclosure may include methods, systems and devices which may further include any and all elements/features from any other disclosed methods, systems, and devices, including any and all features corresponding to translocation control. In other words, features from one and/or another disclosed embodiment may be interchangeable with features from other disclosed embodiments, which, in turn, correspond to yet other embodiments. Furthermore, one or more features/elements of disclosed embodiments may be removed and still result in patentable subject matter (and thus, resulting in yet more embodiments of the subject disclosure). Additionally, some embodiments of the present disclosure are patentable over prior art due to a specific (e.g., express) lack of one and/or another feature(s). To that end, claims to such embodiments may include negative limitations for distinguishing such embodiments from prior art.

1. A method for designing a commercial or residential space via a design application operating on a mobile device, the method comprising:
activating the design application on the mobile device;
selecting a space for design from a plurality of spaces, the plurality of spaces comprising a room, an apartment, a house, a garden, a yard, a commercial space, and combinations thereof;
receiving information on the current design of the space via at least one of:
photos or video scanning of the space, light in the space, color(s) of the space, user preferences, measurements of the space, configuration and/or location of openings in the space, GPS location of the space or a designated location, a neighborhood surrounding the space, current items and/or other features of the space, sounds of and/or adjacent the space, and temperature and/or humidity of the space and/or of the GPS location of the space of a designated location;
determining dimensions of the space;
selecting a design scheme from a plurality of design schemes for designing the space, wherein the plurality of design schemes are stored on at least one database;
determining one or more products and/or services from a listing of products and/or services stored on at least one database, the determined one or more products and/or services being associated with the design scheme;
rendering a virtual map of the space according to the design scheme, the virtual map including a visual representations of at least one of the one or more determined products; and
presenting the virtual map of the space to a user.

2. The method of claim 1, further comprising rendering a virtual map of the current design of the space and/or presenting the virtual map of the current design of the space.

3. The method of claim 1, wherein each of the one or more products is associated with a predetermined supplier.

4. The method of claim 1, wherein each of the one or more services is associated with a predetermined service provider.

5. The method of claim 3, wherein the predetermined supplier is located within a predetermined distance from the GPS location of the space or a designated GPS location.

6. The method of claim 1, further comprising selecting at least one of the one or more products and/or services to purchase and/or hire.

7. The method of claim 3, further comprising ordering the selected at least one product from the corresponding predetermined supplier thereof.

8. The method of claim 4, further comprising ordering the selected at least one service from the corresponding predetermined provider thereof.

9. The method of claim 1, wherein at least one of the determined products and services correspond to promoted products and services.

10. The method of claim 1, wherein presenting the virtual map comprises a virtual tour.

11. The method of claim 1, wherein presenting the virtual map comprises projecting at least a portion of the virtual map onto a wall of the space, wherein the projected portion of the virtual map corresponds to the wall of the space.

12. The method of claim 1, wherein the virtual map is presented via a three-dimensional (3D) visor/glasses.

13. The method of claim 12, wherein hand gestures of the user are captured and presented with the virtual map via the 3D visor.

14. The method of claim 1, further comprising alternately presenting the virtual map of the space according to the design scheme and presenting a virtual map of the current design of the space based on a user input.

15. The method of claim 1, wherein an order of the products and/or services associated with a design scheme is based on a ranking of the products and services.

16. The method of claim 1, wherein each design scheme of the plurality of design schemes is associated with one or more design rules.

17. The method of claim 1, wherein each design scheme of the plurality of design schemes is associated with a designer or architect.

18. The method of claim 1, wherein each design scheme from the plurality of design schemes is associated with at least one of: a budget, style, a budget range, family status, and family size.

19. The method of claim 1 and further comprising at least one of: uploading a picture comprising images from the virtual map, sharing with other users; rating the picture; and receiving feedback from the other users related to the uploaded picture.

20. A method for designing a commercial or residential space via a design application operating on a mobile device, the method comprising:
activating the design application on the mobile device;
selecting a space for design from a plurality of spaces, the plurality of spaces comprising a room, an apartment, a house, a garden, a yard, a commercial space, and combinations thereof;
receiving information on the current design of the space via at least one of photos or video scanning of the space, light in the space, color(s) of the space, user preferences, measurements of the space, configuration and/or location of openings in the space, GPS location of the space or a designated location, a neighborhood surrounding the space, current items and/or other features of the space, sounds of and/or adjacent the space, and temperature and/or humidity of the space and/or of the GPS location of the space or designated GPS location;
determining dimensions of the space;
rendering a first virtual map of the space;
optionally presenting the first virtual map of the space to a user;
selecting a design scheme from a plurality of design schemes stored on at least one database;
accessing a predetermined list of products and/or services available from a listing of predetermined suppliers thereof stored on at least one database, wherein each of the products are associated with one or more specific design schemes of the plurality of design schemes;
determining one or more products and/or services for the space according to the selected design scheme, the one or more products and/or services associated with predetermined suppliers and/or providers thereof, wherein each of the products and/or service is associated with one or more of the design schemes of the plurality of design schemes;
rendering a second virtual map of a design of the space according to the design scheme which includes visual representations of at least one of the one or more determined products;
presenting the second virtual map of the space to the user;
selecting at least one of the one or more products and/or services to purchase and/or hire;
purchasing and/or hiring the selected at least one product and/or services from the corresponding predetermined supplier and/or provider thereof.

21-43. (canceled)
